(19) United States
(12) Patent Application Publication
(10) Pub. No.: US 2018/0023324 A1
(43) Pub. Date: Jan. 25, 2018

(54) PUSH-PULL STRUCTURE

(71) Applicant: SAMSUNG SDS CO., LTD., Seoul (KR)

(72) Inventors: Seong-Jong YOO, Seoul (KR); Young-Kwon KIM, Seoul (KR)

(73) Assignee: SAMSUNG SDS CO., LTD., Seoul (KR)

(21) Appl. No.: 15/641,552

(22) Filed: Jul. 5, 2017

(30) Foreign Application Priority Data
Jul. 4, 2016 (KR) 10-2016-0084297

(51) Int. Cl. E05B 65/10

(52) U.S. Cl. CPC E05B 65/1053

(57) ABSTRACT

One embodiment of the present disclosure relates to a push-pull structure. According to one embodiment of the present disclosure, there is provided a push-pull structure including a first mobile portion and a second mobile portion installed at a handle portion, a first pivoting portion that pivots due to a movement of the first mobile portion and a second pivoting portion that pivots due to the second mobile portion, a connector that connects the first pivoting portion with the second pivoting portion, a pivoting body linked with the connector and connected to a mortise to fasten or release a latch, a reaction structure disposed in the connector and including an elastic member, and a switching member separated from or mounted on the reaction structure. Here, a position of the elastic member is changed by the switching member.

### CROSS-REFERENCE TO RELATED APPLICATION

This application claims priority to and the benefit of Korean Patent Application No. 10-2016-0084297, filed on Jul. 4, 2016, the disclosure of which is incorporated herein by reference in its entirety.

### BACKGROUND

### 1. Field

One embodiment of the present disclosure relates to a push-pull structure.

### 2. Discussion of Related Art

As one of the various types of door locks, there is a push-pull type door lock in which a dead bolt or a latch bolt is released when a force is applied in a direction to open. In the push-pull type door lock, the dead bolt or the latch bolt is released by applying a force to an internal handle and an external handle in a direction to open the door. However, in the above-described push-pull type door lock, since there is a difficulty of separating most of the door lock for push-pull switching and the door lock does not operate when the handle is partially pushed, it is impossible to provide operational reliability.

### SUMMARY

Embodiments of the present disclosure provide a push-pull structure capable of easily switching into a push-pull structure or a pull-push structure.

Embodiments of the present disclosure also provide a push-pull structure capable of providing operational reliability in which a force is definitely transferred to a pivoting body connected to a mortise no matter which part of a handle is pushed.

Embodiments of the present disclosure also provide a push-pull structure configured to be integrated to have improved durability and to be operable without interference even though resistance occurs.

According to one embodiment of the present disclosure, there is provided a push-pull structure including a first mobile portion and a second mobile portion installed at a handle portion, a first pivoting portion that pivots due to a movement of the first mobile portion and a second pivoting portion that pivots due to the second mobile portion, a connector that connects the first pivoting portion with the second pivoting portion, a pivoting body linked with the connector and connected to a mortise to fasten or release a latch (for example, a latch bolt or a dead bolt), a reaction structure disposed in the connector and including an elastic member, and a switching member separated from or mounted on the reaction structure. Here, a position of the elastic member is changed by the switching member.

The push-pull structure may include a fixing member positioned at a lower side of the connector.

The reaction structure may include a guide bar disposed in the connector to guide a movement of the elastic member. The connector may include a first supporter and a second supporter that block a movement of the elastic member at both sides of the guide bar. One end of the elastic member may come into contact with the first supporter or the second supporter and the other end of the elastic member may come into contact with the switching member. The elastic member may be movable to the other side through the switching member.

A through hole may be formed in the other side of the connector. A rack member may be formed at a predetermined part of the circumference of the through hole. The pivoting body may be disposed in the through hole. A pinion member capable of being engaged with the rack member formed in the connector may be formed at at least a part of the pivoting body.

The first pivoting portion and the second pivoting portion may rotationally move due to linear movements of the first mobile portion and the second mobile portion, and the connector may horizontally move due to the rotational movements of the first pivoting portion and the second pivoting portion.

A movement direction of the reaction structure may be perpendicular to a movement direction of the first mobile portion and the second mobile portion.

A groove for disposing the reaction structure may be formed in the connector toward the handle portion or toward the mortise.

When the elastic member comes into contact with the first supporter, the latch may be released by a pushing force. When the elastic member comes into contact with the second supporter opposite the first supporter, the latch may be released by a pulling force.

When the elastic member comes into contact with the second supporter, the latch may be released by a pushing force. When the elastic member comes into contact with the first supporter opposite the second supporter, the latch may be released by a pulling force.

The switching member may be separable from or mountable on the reaction structure disposed in the connector.

A first fastening groove for mounting the switching member may be formed in the fixing member, and a second fastening groove for mounting the switching member may be formed in the connector.

The switching member and the fixing member may be integrated.

A mounting groove may be formed in one side of the switching member, and the switching member may surround one side of a guide bar of the elastic member due to the mounting groove formed in the switching member and may block the elastic member from moving toward the other side.

The reaction structure may include a guide bar that guides a movement of the elastic member. The connector may include an intermediate supporter that blocks the movement of the elastic member in the middle of the guide bar. The switching member may be separated from or mounted on both sides of the guide bar to block the movement of the elastic member or to move the elastic member to the other side.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a view of a push-pull structure according to one embodiment of the present disclosure;

FIGS. 2A and 2B are partial views of the push-pull structure according to one embodiment of the present disclosure;

FIG. 3 is a view illustrating a pivoting body of the push-pull structure according to one embodiment of the present disclosure;

FIGS. 4A and 4B are views illustrating a reaction structure according to one embodiment of the present disclosure;

FIGS. 5A and 5B are views illustrating the reaction structure and a switching member arranged at a connector according to one embodiment of the present disclosure;

FIG. 6 is a view illustrating the switching member according to one embodiment of the present disclosure;

FIG. 7 is a side view of the push-pull structure on which the switching member is mounted according to one embodiment of the present disclosure;

FIG. 8 is an exploded perspective view of the push-pull structure according to one embodiment of the present disclosure; and

FIG. 9 is a view of the push-pull structure in which a position of an elastic member is changed according to one embodiment of the present disclosure.

### DETAILED DESCRIPTION OF EXEMPLARY EMBODIMENTS

Hereinafter, detailed embodiments of the present disclosure will be described with reference to the drawings. However, they are merely examples and the present disclosure is not limited thereto.

In the description of the embodiments of the present disclosure, a certain detailed explanation of a well-known function or component of the related art will be omitted when it is deemed that it may unnecessarily obscure the essence of the present disclosure. Also, the below-described terms are defined in consideration of functions thereof in the embodiments, which may vary according to intentions of a user and an operator or practice. Accordingly, the definitions thereof will be given based on the content throughout the specification.

The technical concept of the present disclosure is defined by the claims, and following embodiments are merely a way for efficiently explaining the technical concept of the present disclosure to one of ordinary skill in the art.

A push-pull structure 1000 according to one embodiment of the present disclosure is a door lock structure mounted on a handle portion of a door and facilitates switching between a push-pull structure and a pull-push structure.

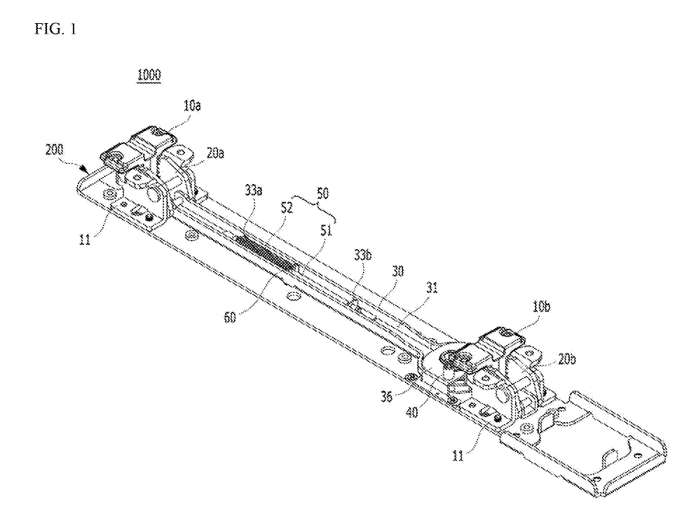

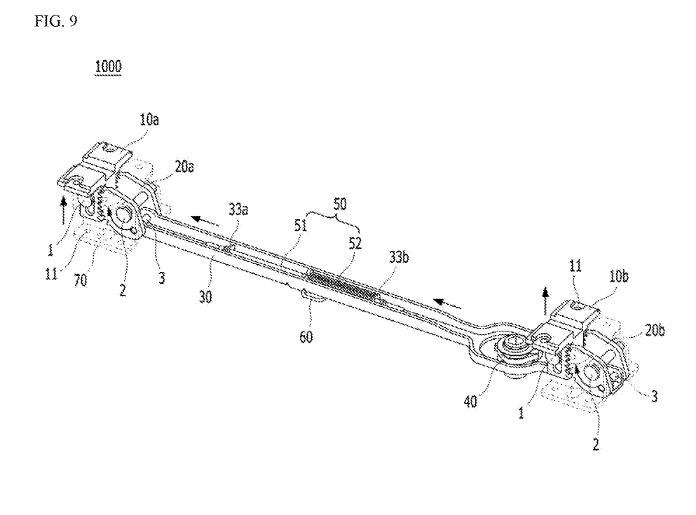

The push-pull structure 1000 may include mobile portions 10a and 10b, pivoting portions 20a and 20b, a connector 30, a pivoting body 40, a reaction structure 50, and a switching member 60. The mobile portions 10a and 10b, the pivoting portions 20a and 20b, the connector 30, the pivoting body 40, and the reaction structure 50 are actuated by receiving an external force, and switching into a push-pull structure and a pull-push structure becomes possible due to the switching member 60. FIG. 1 illustrates a push-pull structure to which a pushing force is transferred, and FIG. 9 illustrates a pull-push structure to which a pulling force is transferred.

FIG. 1 is a view of the push-pull structure 1000 according to one embodiment of the present disclosure.

Referring to FIG. 1, the push-pull structure 1000 includes a first mobile portion 10a and a second mobile portion 10b installed on the handle portion and may include a first pivoting portion 20a that pivots according to a movement of the first mobile portion 10a and a second pivoting portion 20b that pivots due to the second mobile portion 10b. The connector 30 for connecting the first pivoting portion 20a to the second pivoting portion 20b is included, and the pivoting body 40 linked with the connector 30 and connected to a mortise to fasten or release a latch may be included. Also, a reaction structure 50 disposed in the connector 30 and including an elastic member 52 and a switching member 60 separated from or mounted on the reaction structure 50 may be included. A position of the elastic member 52 may be changed in the reaction structure 50 through the switching member 60.

The push-pull structure 1000 may include the first mobile portion 10a and the second mobile portion 10b. The first mobile portion 10a may be disposed at one side of a handle, and the second mobile portion 10b may be disposed at the other side of the handle.

A pushing force or pulling force applied to the handle by a user may be transferred to the first mobile portion 10a and the second mobile portion 10b. The first mobile portion 10a and the second mobile portion 10b may linearly reciprocate in a direction perpendicular to the handle portion. In detail, it is possible perpendicularly move upward and downward according to an arrangement direction of the first mobile portion 10a and the second mobile portion 10b. In other words, the first mobile portion 10a and the second mobile portion 10b may linearly move upward and downward in a direction parallel to a pushing force or a pulling force. When a pushing force is transferred, the first mobile portion 10a and the second mobile portion 10b may linearly move downward (that is, toward the mortise). According to the linear movement of the first mobile portion 10a and the second mobile portion 10b, the first pivoting portion 20a and the second pivoting portion 20b may pivot.

The push-pull structure 1000 may include the first pivoting portion 20a and the second pivoting portion 20b. The first pivoting portion 20a may be disposed to be linked with the first mobile portion 10a, and the second pivoting portion 20b may be disposed to be linked with the second mobile portion 10b. The first pivoting portion 20a and the second pivoting portion 20b may be linked with the first mobile portion 10a and the second mobile portion 10b and may pivot due to the movement of the first mobile portion 10a and the second mobile portion 10b.

When a pushing force is transferred and the first mobile portion 10a and the second mobile portion 10b linearly move downward, the first pivoting portion 20a and the second pivoting portion 20b may pivot counterclockwise. On the other hand, when a pulling force is transferred as shown in FIG. 9, the first mobile portion 10a and the second mobile portion 10b linearly move upward and the first pivoting portion 20a and the second pivoting portion 20b may pivot clockwise.

The connector 30 may connect the first pivoting portion 20a and the second pivoting portion 20a to be mutually linked. The connector 30 may be formed along a longitudinal direction of one side (that is, the mobile portion 10a side) and the other side (that is, the second mobile portion 10b side) of the handle portion at which the first mobile portion 10a and the second mobile portion 10b are arranged. According to the pivoting of the first pivoting portion 20a and the second pivoting portion 20b, the connector 30 may horizontally reciprocate in a longitudinal direction (that is, the one side to the other side). When the first pivoting portion 20a and the second pivoting portion 20b pivot counterclockwise, the connector 30 that links the first pivoting portion 20a with the second pivoting portion 20b may horizontally move from the one side to the other side.

The connector 30 may include a groove 31. The groove 31 may be formed toward the handle portion or toward the mortise. The reaction structure 50 including the elastic member 52 having an elastic force may be disposed in the groove 31. The connector 30 may include a first supporter 33a and a second supporter 33b that block the movement of the elastic member 52 at both sides of the reaction structure 50.

Also, a through hole 36 is formed in the other side of the connector 30 in such a way that the pivoting body 40 may be positioned. A rack member 37 is formed in the through hole 36, and the rack member 37 operates while being engaged with a pinion member 41 formed at the pivoting body 40. A detailed description thereof will be described below with reference to FIG. 3.

The pivoting body 40 may be linked with the connector 30 and may be connected to the mortise of the door. The latch may be released by pivoting of the pivoting body 40. The pivoting body 40 may be positioned in the through hole 36 formed at the other side of the connector 30. The pivoting body 40 may pivot along the horizontal movement of the connector 30. When the connector 30 horizontally moves from the one side to the other side due to a pushing force, the rack member 37 of the connector and the pinion member 41 of the pivoting body 40 30 are engaged with each other and pivot in such a way that the pivoting body 40 may pivot clockwise. The latch of the mortise may be released by pivoting of the pivoting body 40.

The reaction structure 50 may be disposed in the connector 30 and may have a reaction against a pushing force or a pulling force. The reaction structure 50 may be formed with a predetermined length in a center of the connector 30. The predetermined length may be proportional to an operating distance of the door by a pushing force or a pulling force. The reaction structure 50 may include the elastic member 52 compressible and expandable by a pushing force or a pulling force. In detail, the reaction structure 50 may include a guide bar 51 disposed in the connector 30 to guide a movement of the elastic member 52. The elastic member 52 may be compressed and may expand in the guide bar 51. One end of the elastic member 52 may come into contact with the first supporter 33a or the second supporter 33b of the connector 30, and the other end of the elastic member 52 may come into contact with the switching member 60.

The reaction structure 50 may be disposed in the groove 31 of the connector 30 and may horizontally move as the connector 30 horizontally moves. However, a position and a movement direction of the elastic member 52 may be changed by the switching member 60 separated from or mounted on the reaction structure 50.

The switching member 60 may be separated from or mounted on the reaction structure 50. The position of the elastic member 52 may be changed based on the switching member 60. According to the change of the position of the elastic member 52, the push-pull structure 1000 may be actuated by a pushing force or may be actuated by a pulling force. That is, according to an elastic action direction of the elastic member 52, it is possible to switch into a push-pull structure or a pull-push structure actuated by a pushing force or a pulling force.

A fixing member 200 fastened to a bottom of the connector 30 and installed at the handle portion may be included. A bracket 11 for fastening the fixing member 200 to the bottom of the connector 30 may be included. The bracket 11 may be fixed to a pivot 2 and may position the fixing member 200 at the bottom of the connector 30.

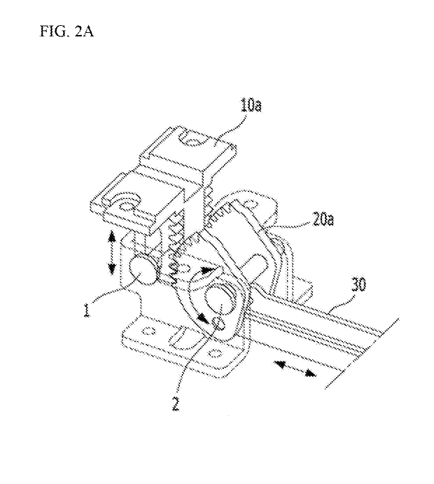

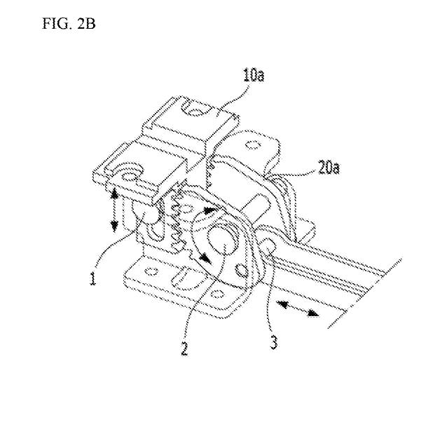

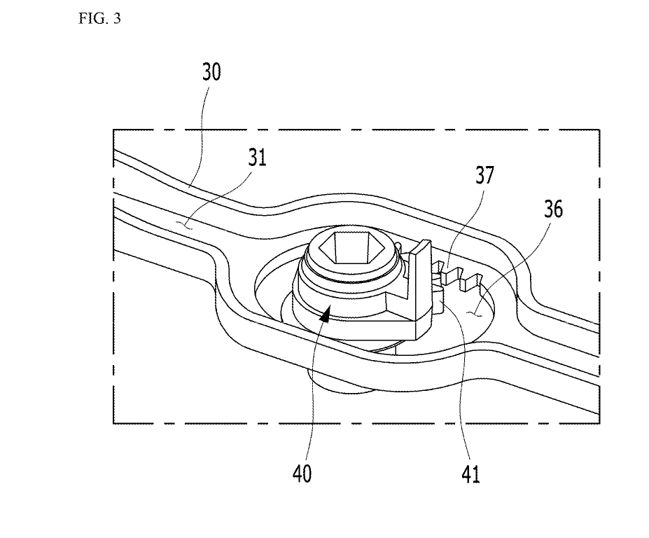

FIGS. 2A and 2B are partial views of the push-pull structure according to one embodiment of the present disclosure. In detail, movements of the first mobile portion 10a, the first pivoting portion 20a, and the connector 30 caused by a pushing force are illustrated.

Referring to FIGS. 2A and 2B, the first mobile portion 10a and the second mobile portion 10b may linearly move due to a pushing force or a pulling force and the first pivoting portion 20a and the second pivoting portion 20b may rotationally move due to the linear movements of the first mobile portion 10a and the second mobile portion 10b. Also, due to the rotational movements of the first pivoting portion 20a and the second pivoting portion 20b, the connector 30 may horizontally move along a connection direction of the first pivoting portion 20a and the second pivoting portion 20b.

FIG. 2A illustrates the first mobile portion 10a before receiving a pushing force, and FIG. 2B illustrates the first mobile portion after receiving a pushing force.

Since shapes and movements of the first mobile portion 10a and the first pivoting portion 20a may be identical or similar to the second mobile portion 10b and the second pivoting portion 20b, the first mobile portion 10a and the first pivoting portion 20a will be mainly described and a description of the second mobile portion 10b and the second pivoting portion 20b will be omitted.

In detail, referring to FIGS. 2A and 2B, the first mobile portion 10a and the first pivoting portion 20a may have gears formed at mutually linked portions to be mutually engaged and operate.

The push-pull structure 1000 according to embodiment may include a mobile shaft 1, a pivot 2, and a fixed shaft 3. A bracket 11 may be fixed to the mobile shaft 1 and the pivot 2. The mobile shaft 1 may be a shaft on which the first mobile portion 10a or the second mobile portion 10b move due to a pushing force or a pulling force. The fixed shaft 3 may fix the first pivoting portion 20a to the connector 30.

The first mobile portion 10a may linearly reciprocate on the mobile shaft 1. The first mobile portion 10a that receives a pushing force may linearly move in a direction perpendicular to the connector 30 (that is, a parallel direction of the force). In detail, the first mobile portion 10a may linearly move downward. As the first mobile portion 10a linearly moves downward, the first pivoting portion 20a linked with the first mobile portion 10a through the gears may pivot counterclockwise.

FIG. 2B is a view illustrating that the first pivoting portion 20a pivots as the first mobile portion 10a linearly moves downward. When the first pivoting portion 20a pivots counterclockwise, the connector 30 fixed to the first pivoting portion 20a by the fixed shaft 3 may horizontally move toward the other side.

FIG. 3 is a view of the pivoting body 40 of the push-pull structure 1000 according to one embodiment of the present disclosure.

Referring to FIG. 3, the pivoting body 40 may be positioned in the through hole 36 formed in the other side of the connector 30. In detail, the through hole 36 may be formed at the other side of the connector 30 and the rack member 37 may be formed at a predetermined part of the circumference of the through hole 36. The predetermined circumference may be determined proportional to a circumference to be pivotable while being engaged with the pinion member 41 formed at the pivoting body 40 and a length for releasing the latch of the mortise connected to the pivoting body 40.

The pivoting body 40 is disposed in the through hole 36, and the pinion member 41 engageable with the rack member 37 formed in the connector 30 may be formed at at least a part of the pivoting body 40.

The rack member 37 formed in the connector 30 and the pinion member 41 formed at the pivoting body 40 may be engaged with each other and may move clockwise or counterclockwise. When a pushing force is received, the connector 30 may be horizontally moved toward the other side and then the pivoting body 40 may pivot counterclockwise. On the other hand, when a pulling force is received, the connector 30 may be horizontally moved toward the one side and then the pivoting body 40 may pivot clockwise. As the pivoting body 40 pivots, the latch of the mortise connected to the pivoting body 40 may be released.

Afterward, when the connector 30 returns to an original position due to the reaction structure 50, the pivoting body 40 may also return to an original position in such a way that the latch may return to a latched state.

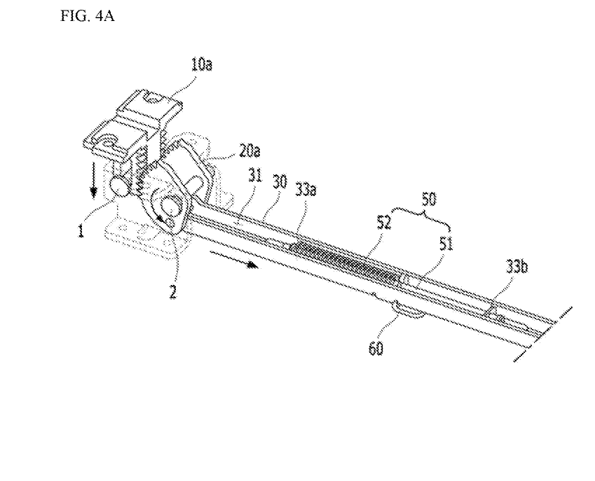

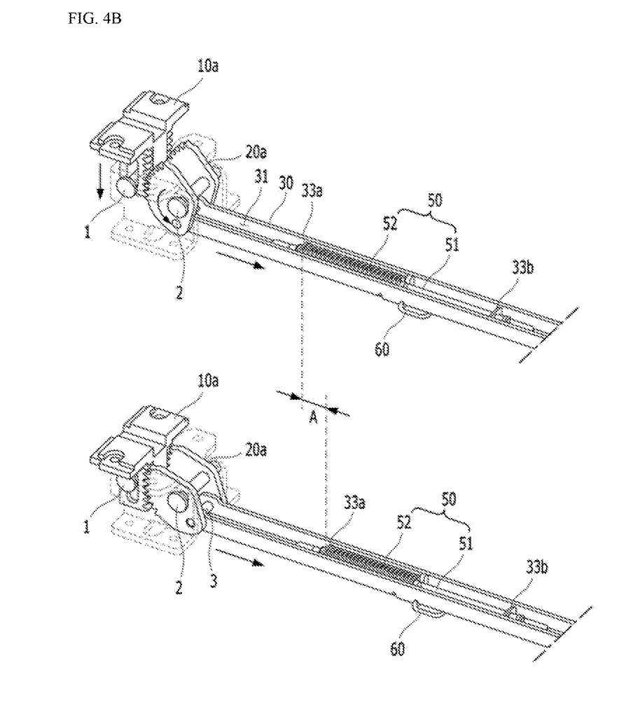

FIGS. 4A and 4B are views of a movement of the reaction structure according to one embodiment of the present disclosure.

Referring to FIGS. 4A and 4B, the reaction structure 50 may have an elastic force by including the elastic member 52 such as a spring. Also, the reaction structure 50 may be disposed in the groove 31 of the connector 30. The reaction structure 50 may include the elastic member 52 and the guide bar 51 that guides a movement of the elastic member 52.

The first supporter 33a and the second supporter 33b provided in the connector 30 may be arranged at both sides of the guide bar 51 in such a way that the movement of the elastic member 52 may be blocked by the first supporter 33a or the second supporter 33b.

The one end of the elastic member 52 may be disposed in contact with the first supporter 33a or the second supporter 33b. The elastic member 52 may be disposed to have a length shorter than a length of the guide bar 51 and an elastic force that allows the latch to return to the latched state. The one end of the elastic member 52 may come into contact with the first supporter 33a or the second supporter 33b, and the other end thereof may come into contact with the switching member 60. In detail, the one end of the elastic member 52 in contact with the first supporter 33a or the second supporter 33b may horizontally move according to a horizontal movement of the connector 30 and the other end of the elastic member 52 may be fixed to the switching member 60. That is, the one end of the elastic member 52 is movable and the other end thereof is fixed in such a way that the elastic member 52 may be compressed, expand, and have an elastic force.

The elastic member 52 may be disposed nonparallel to the first mobile portion 10a and the second mobile portion 10b. In detail, a movement direction of the reaction structure 50 may be perpendicular to a movement direction of the first mobile portion 10a and the second mobile portion 10b.

The push-pull structure 1000 according to one embodiment of the present disclosure may be actuated by a pushing force or a pulling force and it is shown being actuated by the pushing force in FIGS. 4A and 4B.

When the pushing force is transferred to the handle, the first mobile portion 10a and the second mobile portion 10b linearly move and the first pivoting portion 20a and the second pivoting portion 20b may pivot counterclockwise toward the connector 30. Accordingly, the connector 30 may horizontally move toward the other side. The reaction structure 50 disposed in the connector 30 may horizontally move along a direction in which the connector 30 horizontally moves.

When the reaction structure 50 horizontally moves, the elastic member 52 may be compressed by the switching member 60 that fixes the other end of the elastic member 52. The elastic member 52 may have an elastic force as much as a compression distance A and may have a reaction force for returning to an original state. Accordingly, in a state in which a force is not transferred, the elastic member 52 returns to the original position and then the mobile portions 10a and 10b, the pivoting portions 20a and 20b, the connector 30, and the pivoting body 40 return to original positions in such a way that the latch of the mortise connected to the pivoting body may return to the latched state again.

When the elastic member 52 is disposed beside the first supporter 33a of the connector 30, the latch may be released by a pushing force. When the elastic member 52 is disposed beside the second supporter 33b opposite to the first supporter 33a, the latch may be released by a pulling force. However, the push-pull structure 1000 according to the embodiment is not limited thereto. On the other hand, the latch may be released by a pushing force when the elastic member 52 comes into contact with the second supporter 33b and may be released by a pulling force when the elastic member 52 comes into contact with the first supporter 33a opposite to the second supporter 33b. The above may be determined depending on the setting of a user, a position at which the push-pull structure 1000 is positioned, or the like.

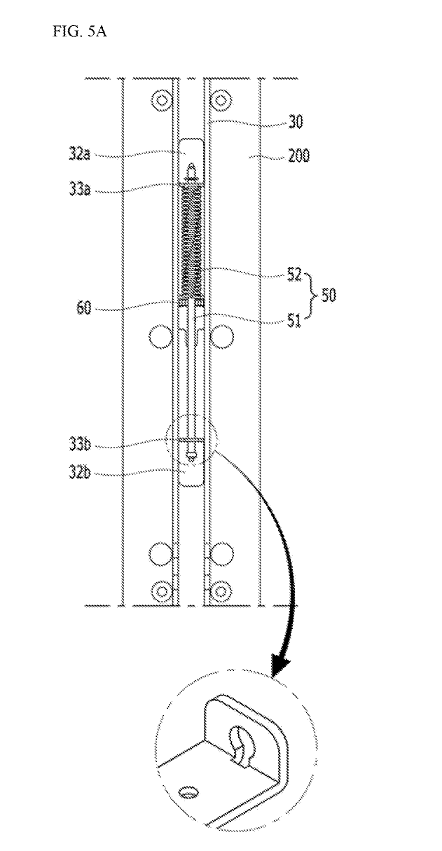

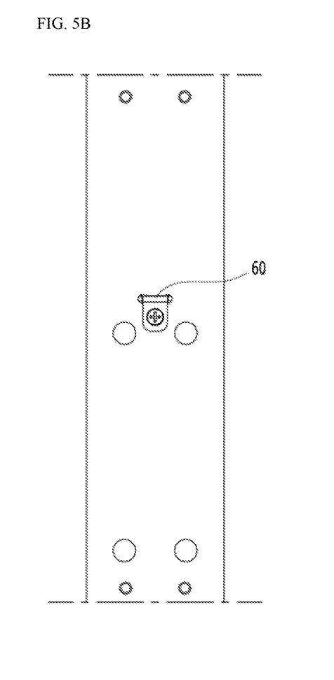

FIGS. 5A and 5B are views illustrating the reaction structure and a switching member arranged in a connector according to one embodiment of the present disclosure.

FIG. 5A is a view illustrating the reaction structure 50 disposed in the connector 30 and the switching member 60 mounted on the fixing member 200, and FIG. 5B is a view illustrating the switching member 60 mounted on the fixing member 200.

Referring to FIG. 5, the fixing member 200 may be disposed below the connector 30. The switching member 60 mounted on the fixing member 200 may be mounted on the reaction structure 50 as the fixing member 200 is fastened to a bottom of the connector 30.

The groove 31 may be formed in the connector 30, and a first guide fixing member 32a and a second guide fixing member 32b may be provided in the groove 31. The first guide fixing member 32a and the second guide fixing member 32b may be integrated with the connector 30 or may be mounted thereon. The first guide fixing member 32a and the second guide fixing member 32b may be disposed at both sides of the guide bar 51 and may fix the guide bar 51 to the connector 30. The first supporter 33a and the second supporter 33b may be formed at the first guide fixing member 32a and the second guide fixing member 32b. The first supporter 33a and the second supporter 33b, as described above, may block the movement of the elastic member 52 that moves within the guide bar 51.

In detail, the elastic member 52 disposed between the first supporter 33a and the switching member 60 may be compressed and expand while the connector 30 moves due to a pushing force. On the other hand, after the switching member 60 is separated and then the elastic member 52 is allowed to come into contact with the second supporter 33b, the switching member 60 may be mounted again. The elastic member 52 disposed between the second supporter 33b and the switching member 60 may be compressed and expand while the connector 30 moves due to a pulling force.

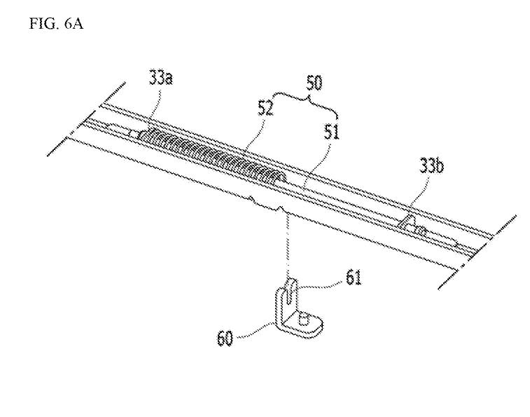

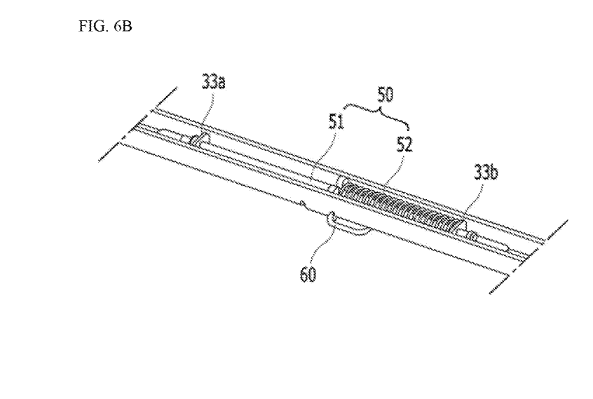

FIG. 6 is a view illustrating the switching member 60 according to one embodiment of the present disclosure.

Referring to FIG. 6, the switching member 60 is separable from or mountable on the reaction structure 50 and a position of the elastic member 52 may be changed by the separation of the switching member 60.

The switching member 60 may be mounted on the guide bar 51 and may block the movement of the elastic member 52 in contact with one of the first supporter 33a and the second supporter 33b. Also, the switching member 60 may be separated from the guide bar 51 and thus may move the elastic member 52 toward the other side. The switching member 60 may include a mounting groove 61 to be mountable on the guide bar 51 of the reaction structure 50. The mounting groove 61 may be formed to correspond to and be similar to a size and a shape of the guide bar 51.

The switching member 60 may pass through and be inserted in the connector 30 and may be fixed to and mounted on the guide bar 51. Accordingly, a movement of the elastic member 52 toward the other side may be blocked.

The push-pull structure 1000 according to one embodiment of the present disclosure may move the position of the elastic member 52 by separating or mounting the switching member 60. Switching into a push-pull structure or a pull-push structure may be easily performed by moving the position of the elastic member 52. For example, when the elastic member 52 is fixed between the first supporter 33a and the switching member 60, the latch may be released by a pushing force. When a change to the latch being released by a pulling force in this state is wanted, the elastic member 52 may be moved toward the second supporter 33b by separating the switching member 60 and the switching member 60 may be mounted again. Accordingly, the latch may be released by a pulling force by using the elastic member 52 fixed between the second supporter 33b and the switching member 60.

The push-pull structure 1000 according to the embodiment may facilitate switching into a push-pull structure and a pull-push structure by changing the position of the elastic member 52 by separating or mounting the switching member 60. The groove 31 of the connector 30 may be formed to approach the handle portion or the mortise. For example, when the groove 31 of the connector 30 is formed downward, switching into a push-pull structure or a pull-push structure may be facilitated. In detail, by forming an opening only at a position of the reaction structure 50 in a bottom of the push-pull structure 1000, the switching member 60 may be separated without separating the push-pull structure 1000 and may be mounted again by changing the position of the elastic member 52 of the reaction structure 50.

Additionally, although not shown in the drawings, according to another embodiment of the present disclosure, the position of the switching member 60 may be changed. In detail, the connector 30 may include an intermediate supporter (not shown) that blocks the movement of the elastic member 52 in the middle of the guide bar 51. In this case, the switching member 60 may be separated from or mounted on both sides of the guide bar 51 to block the movement of the elastic member 52 or to move to the other side.

In more detail, the intermediate supporter that fixes the guide bar 51 and simultaneously blocks the movement of the elastic member 52, that is, compresses the elastic member 52 as the connector 30 moves may be provided in the connector 30. Accordingly, the intermediate supporter may be provided in the center of the guide bar 51 and the switching member 60 may be mounted at both side ends.

The one end of the elastic member 52 may come into contact with the intermediate supporter to block the movement thereof, and the other end of the elastic member 52 may come into contact with the switching member 60. Accordingly, the elastic member 52 may be positioned between the intermediate supporter and the switching member 62.

When the connector 30 moves due to a pushing force, the elastic member 52 may move due to the movement of the connector 30. Here, the intermediate supporter integrated with and fixed to the connector 30 may move with the connector 30 and the elastic member 52 may be compressed by the switching member 60 whose position is fixed by the fixing member 200.

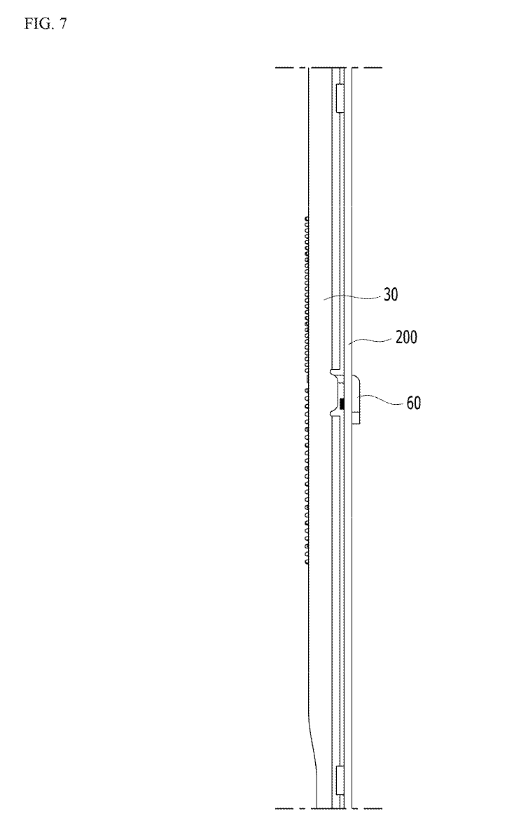

FIG. 7 is a side view of the push-pull structure on which the switching member is mounted according to one embodiment of the present disclosure.

Referring to FIG. 7, the switching member 60 may be mounted from a bottom of the fixing member 200 and then may be mounted on the guide bar 51 disposed in the connector 30.

However, a shape of the switching member 60 is not limited thereto and the switching member 60 may be integrated with the fixing member 200. As the fixing member 200 is disposed below the connector 30, the switching member 60 integrated with the fixing member 200 may be mounted on the guide bar 51.

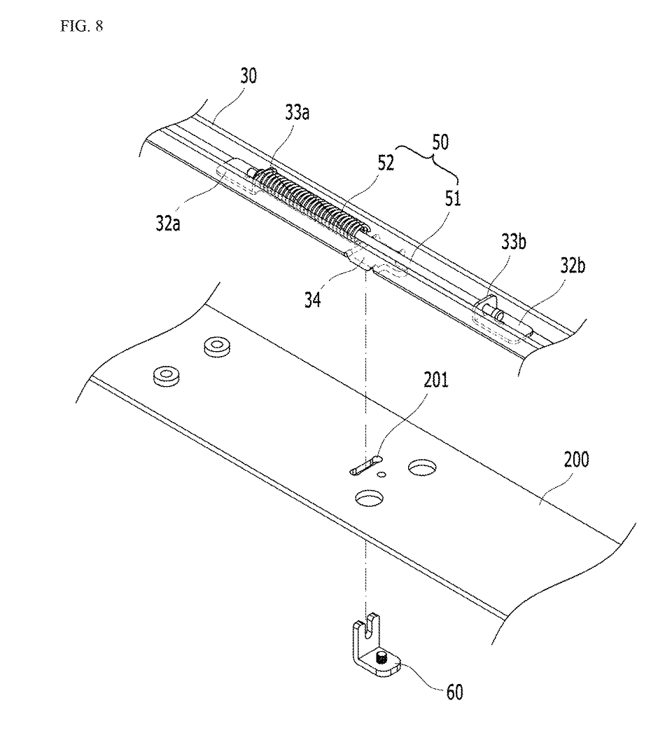

FIG. 8 is an exploded perspective view of the push-pull structure according to one embodiment of the present disclosure.

Referring to FIG. 8, a first fastening groove 201 for mounting the switching member 60 may be formed in the fixing member 200 and a second fastening groove 34 for mounting the switching member 60 may be formed in the connector 30. Accordingly, the switching member 60 may be mounted on the guide bar 51 through the first fastening groove 201 and the second fastening groove 34.

FIG. 9 is a view of a pull-push structure actuated by a pulling force according to one embodiment of the present disclosure.

Referring to FIG. 9, the elastic member 52 of the reaction structure 50 may be positioned between the second supporter 33b and the switching member 60. When the one end of the elastic member 52 is in contact with the second supporter 33b and the other end thereof is in contact with the switching member 60, the latch may be released by a pulling force.

In this case, initial positions of the first mobile portion 10a and the second mobile portion 10b may be moved downward. When the pulling force is transferred, the first mobile portion 10a and the second mobile portion 10b may linearly move upward (that is, toward the handle portion).

In detail, the pull-push structure in which the latch is released by a pulling force may be in a state in which the first mobile portion 10a and the second mobile portion 10b are linearly moved downward. According to the state in which the first mobile portion 10a is moved downward, the gears of the first mobile portion 10a and the first pivoting portion 20a may be entirely engaged with each other. The second mobile portion 10b and the second pivoting portion 20b may be in the same state.

Accordingly, the first mobile portion 10a and the second mobile portion 10b are linearly moved upward by the pulling force, and then the first pivoting portion 20a and the second pivoting portion 20b pivot clockwise. As the connector 30 linked with the first pivoting portion 20a and the second pivoting portion 20b horizontally moves from the other side to the one side and the pivoting body 40 linked with the rack member 37 of the connector 30 pivots clockwise, the latch may be released by a structure in the mortise connected to the pivoting body 40.

According to the embodiments of the present disclosure, a push-pull structure capable of easily switching into a push-pull structure or a pull-push structure can be provided.

Also, a push-pull structure capable of providing operational reliability in which a force is definitely transferred to a pivoting body connected to a mortise no matter which part of a handle is pushed can be provided.

Also, a push-pull structure configured to be integrated to have improved durability and to be operable without interference even though resistance occurs can be provided.

Although representative embodiments of the present disclosure have been described in detail, it will be understood by one of ordinary skill in the art that various changes in form and details may be made therein without departing from the spirit and scope of the present disclosure. Therefore, the scope of the present disclosure is not limited to and defined by the above-described embodiments but should be defined by the scope of the following claims and equivalents thereof.

What is claimed is:

1. A push-pull structure comprising:
a first mobile portion and a second mobile portion, the first and the second mobile portions being disposed on a handle portion of a door;
a first pivoting portion that pivots based on a movement of the first mobile portion;
a second pivoting portion that pivots based on a movement of the second mobile portion;
a connector that connects the first pivoting portion with the second pivoting portion;
a pivoting body linked with the connector and connected to a mortise, the pivoting bodying being configured to fasten or release a latch;
a reaction structure disposed in the connector and comprising an elastic member; and
a switching member separated from or mounted on the reaction structure,
wherein a position of the elastic member is changed by the switching member.

2. The push-pull structure of claim 1, wherein the push-pull structure further comprises a fixing member positioned below the connector.

3. The push-pull structure of claim 1, wherein the reaction structure comprises a guide bar configured to guide a movement of the elastic member,
wherein the connector comprises a first supporter and a second supporter, the first and the second supporters being configured to block a movement of the elastic member at both sides of the guide bar,
wherein one end of the elastic member comes into contact with the first supporter or the second supporter and another end of the elastic member comes into contact with the switching member, and
wherein the elastic member is movable in a direction opposite to the one end in contact with the first supporter or the second supporter via the switching member.

4. The push-pull structure of claim 1, wherein a through hole is formed in the connector on an opposite side of the first supporter and the second supporter,
wherein a rack member is formed in part of a circumference of the through hole,
wherein the pivoting body is disposed in the through hole, and
wherein a pinion member configured to be engaged with the rack member is formed in at least a part of the pivoting body.

5. The push-pull structure of claim 1, wherein the first pivoting portion and the second pivoting portion rotationally move based on linear movements of the first mobile portion and the second mobile portion, and
wherein the connector horizontally moves based on the rotational movements of the first pivoting portion and the second pivoting portion.

6. The push-pull structure of claim 1, wherein a movement direction of the reaction structure is perpendicular to a movement direction of the first mobile portion and the second mobile portion.

7. The push-pull structure of claim 1, wherein a groove is formed in the connector toward the handle portion or toward the mortise, and
wherein the reaction structure is disposed in the groove.

8. The push-pull structure of claim 3, wherein when the elastic member comes into contact with the first supporter, the latch is released by a pushing force, and
wherein when the elastic member comes into contact with the second supporter, the latch is released by a pulling force.

9. The push-pull structure of claim 3, wherein when the elastic member comes into contact with the second supporter, the latch is released by a pushing force, and
wherein the elastic member comes into contact with the first supporter, the latch is released by a pulling force.

10. The push-pull structure of claim 2, wherein a first fastening groove for mounting the switching member is formed in the fixing member, and
wherein a second fastening groove for mounting the switching member is formed in the connector.

11. The push-pull structure of claim 2, wherein the switching member and the fixing member are integrated with each other.

12. The push-pull structure of claim 1, wherein a mounting groove is formed in one side of the switching member,
wherein the switching member surrounds one side of a guide bar, the guide bar being configured to guide a movement of the elastic member, and
wherein due to the mounting groove formed in the switching member, the switching member blocks the elastic member from moving toward a side opposite of the switching member.

13. The push-pull structure of claim 1, wherein the reaction structure comprises a guide bar that guides a movement of the elastic member,
wherein the connector comprises an intermediate supporter that blocks a movement of the elastic member in the middle of the guide bar, and
wherein the switching member is separated from or mounted on both sides of the guide bar to block a movement of the elastic member or to move the elastic member toward a side opposite of the switching member.
